(19) United States
(12) Patent Application Publication
(10) Pub. No.: US 2011/0085147 A1
(43) Pub. Date: Apr. 14, 2011

(54) LIGHT SOURCE DEVICE AND PROJECTION DISPLAY DEVICE

(75) Inventors: Junichi SUZUKI, Chino (JP); Hideaki KOIKE, Chino (JP); Satoshi FUJII, Sanda (JP); Hayato AGATA, Suwa (JP); Satoshi KITO, Chino (JP); Norio IMAOKA, Takamori (JP)

(73) Assignee: SEIKO EPSON CORPORATION, Tokyo (JP)

(21) Appl. No.: 12/880,562

(22) Filed: Sep. 13, 2010

(30) Foreign Application Priority Data
Oct. 13, 2009 (JP) 2009-235997

(51) Int. Cl. G03B 21/28; H01J 7/46

(52) U.S. Cl. 353/98; 315/39

(57) ABSTRACT

A light source device includes: a microwave generating section generating microwaves; a central conductor connected to the microwave generating section and emitting the microwaves; a discharge lamp connected to the central conductor and emitting light by the microwaves; and a reflector surrounding the discharge lamp, the reflector which has an opening at one end thereof and is formed of conductor material, wherein the relationship between a wavelength λ of the microwaves, an inside surface length D which is an inside diameter of the opening of the reflector or a maximum length of a cross-sectional shape of the opening of the reflector, and a length L from a first end of the discharge lamp opposite to a second end connected to the central conductor to the opening of the reflector is D≦λ/2 and L/D≧0.8.

### BACKGROUND

1. Technical Field

The present invention relates to a light source device having a discharge lamp emitting light by irradiation with microwaves and a projection display device provided with the light source device.

2. Related Art

In recent years, the demand for discharge lamps as a high-luminance light source has been increasing in place of halogen lamps. In particular, in discharge lamps using microwaves for discharge lighting of a lamp, a discharge lamp with an electrode has a longer lifetime because, in this discharge lamp, the electrode is resistant to exhaustion as compared to an existing discharge lamp operated on direct current and alternating current. Moreover, it is possible to realize a lamp with no electrode by using microwaves, and this promises a longer-life lamp.

On the other hand, since the discharge lamp using microwaves performs discharge lightning with high-frequency power, strong electromagnetic waves are generated at the time of discharge. If leakage of the electromagnetic waves occurs, extraneous emissions are produced and affect nearby electronic devices. Therefore, it is necessary to cut off the electromagnetic waves.

For example, a light source device of JP-A-2008-262833 (Patent Document 1) reduces electromagnetic waves which leak out by attaching a tubular part to an opening of a lamp.

Leakage of electromagnetic waves in the light source device is prevented by making the inside diameter of an opening smaller and making the tubular part longer. However, doing so results in a reduction in light use efficiency. Moreover, to improve the light use efficiency, it is necessary to make the inside diameter of an opening larger and making the tubular part shorter. As described above, preventing leakage of electromagnetic waves and improving the light use efficiency are mutually contradictory, making it difficult to prevent leakage of electromagnetic waves while improving the light use efficiency.

In addition, attaching a tubular part as in Patent Document 1 makes the light source device undesirably large.

### SUMMARY

An advantage of some aspect of the invention is to solve at least part of the problems described above, and the invention can be realized as an embodiment or an application example described below.

### APPLICATION EXAMPLE 1

A light source device according to this application example includes: a microwave generating section generating microwaves; a central conductor connected to the microwave generating section and emitting the microwaves; a discharge lamp connected to the central conductor and emitting light by the microwaves; and a reflector surrounding the discharge lamp, the reflector which has an opening at one end thereof and is formed of conductor material, wherein the relationship between a wavelength λ of the microwaves, an inside surface length D which is an inside diameter of the opening of the reflector or a maximum length of a cross-sectional shape of the opening of the reflector, and the length L from a first end of the discharge lamp opposite to a second end connected to the central conductor to the opening of the reflector is D≦λ/2 and L/D≧0.8.

With this structure, the relationship between a wavelength λ of the microwaves, an inside surface length D which is an inside diameter of the opening of the reflector or a maximum length of a cross-sectional shape of the opening of the reflector, and a length L from a first end of the discharge lamp opposite to a second end connected to the central conductor to the opening of the reflector is set so that D≦λ/2 and L/D≧0.8.

By doing so, it is possible to improve the use efficiency of the light emitted from the discharge lamp while keeping the amount of electromagnetic waves which leak out from the light source device less than or equal to a predetermined value. Moreover, it is possible to reduce the leaked electromagnetic waves without attaching other parts to the reflector and miniaturize the light source device.

### APPLICATION EXAMPLE 2

In the light source device according to the application example described above, it is preferable that a surface of the reflector, the surface facing the discharge lamp, be formed of at least metal material.

As described above, since the surface of the reflector is formed of at least metal material, the generated electromagnetic waves are cut off by the metal material.

### APPLICATION EXAMPLE 3

In the light source device according to the application example described above, it is preferable that the discharge lamp be placed in an optical focal position of the reflector.

As described above, since the discharge lamp is placed in an optical focal position of the reflector, the luminous flux emitted from the discharge lamp is guided to the outside while being efficiently reflected by the reflector, making it possible to reduce optical loss which occurs when reflection occurs.

### APPLICATION EXAMPLE 4

In the light source device according to the application example described above, it is preferable that a transmission mode of high-frequency waves transmitted from the microwave generating section be a TEM mode.

With this structure, as a transmission mode of high-frequency waves transmitted from the microwave generating section, a TEM (transverse electro magnetic) mode in which an electric field component and a magnetic field component are zero in the direction of propagation of waves is used. Therefore, a microwave transmission loss is small, making it possible to transmit the microwaves efficiently.

### APPLICATION EXAMPLE 5

In the light source device according to the application example described above, it is preferable that the reflector include an optical element which efficiently focuses or polarizes light on an optical axis of luminous flux emitted from the discharge lamp.

As described above, by providing the reflector with an optical element such as an optical lens, it is possible to shorten the light guiding distance from the light source to the optical element and improve the light use efficiency. Since a condenser lens and a collimator lens can be used as the optical element, it is possible to condense luminous flux or convert luminous flux into parallel light at a luminous flux exit of the light source device. This increases optical design flexibility.

### APPLICATION EXAMPLE 6

A projection display device according to this application example includes: a light source device; a light modulating section forming an optical image by modulating luminous flux emitted from the light source device according to input image information; and a projecting section projecting the optical image formed by the light modulating section, the light source device including: a microwave generating section generating microwaves; a central conductor connected to the microwave generating section and emitting the microwaves; a discharge lamp connected to the central conductor and emitting light by the microwaves; and a reflector surrounding the discharge lamp, the reflector which has an opening at one end thereof and is formed of conductor material, the light source device in which the relationship between a wavelength λ of the microwaves, an inside surface length D which is an inside diameter of the opening of the reflector or a maximum length of a cross-sectional shape of the opening of the reflector, and a length L from a first end of the discharge lamp opposite to a second end connected to the central conductor to the opening of the reflector is D≦λ/2 and L/D≧0.8.

With this structure, it is possible to provide a projection display device with high use efficiency of the light emitted from the discharge lamp while keeping the amount of electromagnetic waves which leak out from the light source device less than or equal to a predetermined value.

### BRIEF DESCRIPTION OF THE DRAWINGS

The invention will be described with reference to the accompanying drawings, wherein like numbers reference like elements.

FIG. 1 is a schematic sectional view showing the structure of a light source device of a first embodiment.

FIG. 2 is a block diagram showing the schematic configuration of a microwave generating section of the first embodiment.

FIG. 3 is a graph showing the relationship between the ratio L/D between the length L from an end of a discharge lamp of the first embodiment to an opening of a reflector and an inside surface length D of the opening of the reflector and the attenuation effect.

FIGS. 4A and 4B are schematic sectional views showing the structures of Modified Example 1 of the first embodiment.

FIG. 5 is a schematic sectional view showing the structure of Modified Example 2 of the first embodiment.

FIG. 6 is a block diagram showing the schematic configuration of a projector of a second embodiment.

### DESCRIPTION OF EXEMPLARY EMBODIMENTS

Hereinafter, an embodiment of the invention will be described with reference to the drawings. Incidentally, in the drawings used in the following description, the dimensional ratio is appropriately changed in order to make the elements easily recognizable.

### First Embodiment

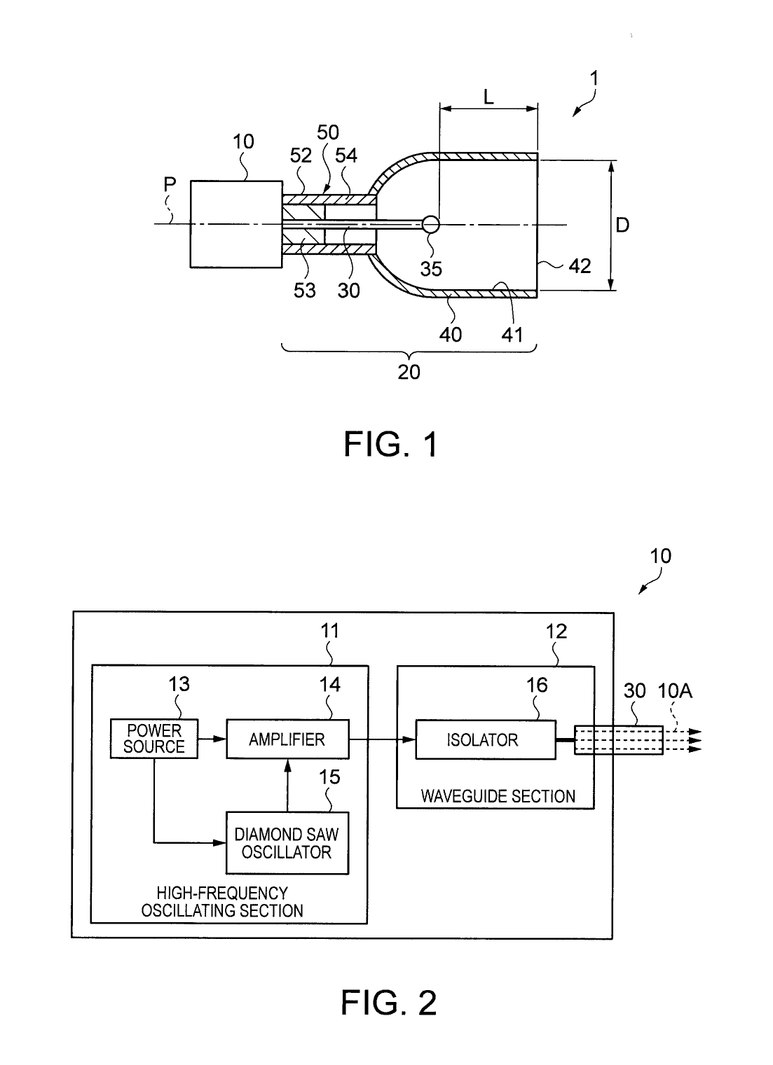

FIG. 1 is a sectional view showing the schematic structure of a light source device of this embodiment.

A light source device 1 includes a microwave generating section 10 generating microwaves and a light-emitting section 20 involved in emission of light by using the microwaves.

The light-emitting section 20 has a coaxial tube 50, a central conductor 30, a discharge lamp 35, and a reflector 40.

The coaxial tube 50 has a connector portion 52, an outer tube 54, and the central conductor 30, and is connected to the microwave generating section 10 at the connector portion 52.

The central conductor 30 is formed into a circular cylinder. The central conductor 30 extends in the direction of an optical axis P from the inside of the microwave generating section 10, and emits microwaves generated by the microwave generating section 10. In addition, the outer tube 54 is provided in such a way that the central conductor 30 is surrounded thereby equidistantly. Incidentally, as the central conductor 30 and the outer tube 54, a conductor formed of metal such as copper or a dielectric formed of silica glass or the like is used. Moreover, in the connector portion 52, an insulating member 53 such as ceramic or fluoroplastic is provided between the central conductor 30 and the outer tube 54 to prevent shorting thereof.

In this way, the coaxial tube 50 having the central conductor 30 as an inner conductor and the outer tube 54 as an outer conductor is formed, making it possible to transmit the microwaves in the direction of the optical axis P.

Incidentally, as a transmission mode of high-frequency waves transmitted from the microwave generating section 10, a TEM (transverse electro magnetic) mode in which an electric field component and a magnetic field component are zero in the direction of propagation of waves is used. Therefore, a microwave transmission loss is small, making it possible to transmit the microwaves efficiently.

Moreover, a commonly-used frequency as a microwave band is generally 3 to 30 GHz. In this embodiment, however, frequencies from 300 MHz to 30 GHz corresponding to a frequency band from the UHF band to the SHF band are defined as a microwave band.

The reflector 40 is formed into a shape that allows light to become a parallel light or to be focused optically, and has an optical free-form surface. The reflector 40 has an opening at one end thereof and is connected to the coaxial tube 50 at the other end thereof.

The reflector 40 is dome-shaped in a part thereof near the coaxial tube 50, and has a tubular shape from that part to an opening 42.

The reflector 40 is formed of metal such as aluminum which is conductor material, and is grounded. By doing so, the electromagnetic waves cut off by the reflector 40 are electrically grounded.

Moreover, an inner surface 41 of the reflector 40 is formed as a mirror surface with light reflectivity of 90% or more. The inner surface 41 reflects the microwaves, and guides the luminous flux emitted by the discharge lamp 35 to the outside through the opening 42 of the reflector 40 while reflecting the luminous flux.

Incidentally, even if the whole reflector 40 is not formed of metal material, the surface of the reflector 40, the surface facing the discharge lamp 35, only has to be formed of metal material and electrically grounded.

The central conductor 30 sticks out of the coaxial tube 50 into the reflector 40, and the discharge lamp 35 is provided at the tip of the central conductor 30. The reflector 40 is formed so as to surround the discharge lamp 35, and the discharge lamp 35 is placed in an optical focal position of the reflector 40.

As described above, since the discharge lamp 35 is placed in the optical focal position of the reflector 40, the luminous flux emitted from the discharge lamp 35 is guided to the outside while being efficiently reflected by the reflector 40. This makes it possible to reduce optical loss which occurs when reflection occurs.

The discharge lamp 35 is formed by encapsulating light-emitting material emitting light by the microwaves in a transparent container made of silica glass, transparent ceramic, or the like, which is nonconductive material. As the light-emitting material to be encapsulated, a noble gas such as neon, argon, krypton, or xenon, mercury, or a metallic halide is used.

Incidentally, the discharge lamp 35 may have a structure with an electrode or may have a structure with no electrode.

Here, the relationship between a wavelength λ of the microwaves, an inside surface length D which is an inside diameter of the opening 42 of the reflector 40, and a length L from an end of the discharge lamp 35 opposite to an end connected to the central conductor to the opening 42 of the reflector 40 is set so that D≦λ/2 and L/D≧0.8.

Incidentally, when the opening 42 of the reflector 40 has a rectangular or elliptical cross-sectional shape, the length of a long side of a hollow space is assumed to be D. A long side of a hollow space refers to the maximum length of a cross-sectional shape of a hollow space of a tubular object.

Next, the configuration of the microwave generating section will be described with reference to the drawing.

FIG. 2 is a block diagram showing the schematic configuration of the microwave generating section. The microwave generating section 10 includes a high-frequency oscillating section 11 outputting a high-frequency signal and a waveguide section 12 emitting the high-frequency signal output from the high-frequency oscillating section 11 as microwaves.

The high-frequency oscillating section 11 has a power source 13, a surface acoustic wave (SAW) oscillator serving as a high-frequency oscillator, and an amplifier 14. In this embodiment, as the surface acoustic wave oscillator, a diamond SAW oscillator 15 is adopted. The waveguide section 12 has the central conductor 30 and an isolator 16 serving as a cutout.

The high-frequency oscillating section 11 will be described in detail. The power source 13 supplies power to the diamond SAW oscillator 15 and the amplifier 14. The output end of the diamond SAW oscillator 15 is connected to the input end of the amplifier 14. The high-frequency signal output from the diamond SAW oscillator 15 is amplified by the amplifier 14 and is then output therefrom. The high-frequency signal output from the amplifier 14 becomes a high-frequency signal which is output from the high-frequency oscillating section 11.

In this embodiment, a high-frequency signal (in this embodiment, a high-frequency signal at 2.45 GHz with a wavelength λ of about 12 cm) amplified to a high-frequency output level at which the light-emitting material encapsulated in the discharge lamp 35 is excited and is made to emit light is output from the high-frequency oscillating section 11.

Next, the waveguide section 12 will be described in detail. The waveguide section 12 guides the high-frequency signal output from the high-frequency oscillating section 11 and emits the high-frequency signal as microwaves 10A. The waveguide section 12 includes the central conductor 30 from which the microwaves 10A are emitted and the isolator 16 as a measure against reflected waves.

The central conductor 30 is a central conductor emitting microwaves with unidirectionality. The central conductor 30 makes it possible to emit the microwaves 10A which are nearly plane waves.

The isolator 16 is placed at the output end of the amplifier 14 between the amplifier 14 and the central conductor 30. This helps prevent the reflected waves produced as a result of the microwaves 10A being emitted from the central conductor 30 from returning to the high-frequency oscillating section 11.

In the above-structured light source device 1, the microwave generating section 10 generates a high-frequency signal and emits the high-frequency signal as microwaves into the reflector 40. The microwaves thus emitted are nearly plane waves, and are reflected from the inner surface 41 of the reflector 40. The microwaves thus reflected converge to the center of the discharge lamp 35. As a result of the encapsulated light-emitting material being exited (and ionized) and producing plasma emission by the microwaves which have converged to the discharge lamp 35, the discharge lamp 35 emits light.

As a result of the discharge lamp 35 emitting light, luminous flux is emitted. Part of the emitted luminous flux reaches the reflector 40 and is reflected thereby. Then, the luminous flux is guided to the outside through the opening 42 while being reflected from the inner surface 41 of the reflector 40.

Next, the reason why the relationship between the wavelength λ of the microwaves, the inside surface length D which is the inside diameter of the opening 42 of the reflector 40, and the length L from an end of the discharge lamp 35 to the opening 42 of the reflector 40 is set so that D≦λ/2 and L/D≧0.8 will be described.

First, the reason why the relationship between the wavelength λ of the microwaves and the inside surface length D of the opening 42 of the reflector 40 is D≦λ/2 is as follows.

When D=λ/2, the electromagnetic waves generated from the microwaves become wave nodes at the opening 42 of the reflector 40, and most of the electromagnetic waves are reflected and stay in the reflector 40. When D<λ/2, the electromagnetic waves generated from the microwaves have no resonance portion at the opening 42 of the reflector 40, and most of the electromagnetic waves cannot go outside.

Therefore, by setting D≦λ/2, it is possible to reduce leakage of electromagnetic waves from the light source device 1.

Subsequently, L/D≧0.8 which is the relationship between the inside surface length D of the opening 42 of the reflector 40 and the length L from an end of the discharge lamp 35 to the opening 42 of the reflector 40 is obtained by an experiment.

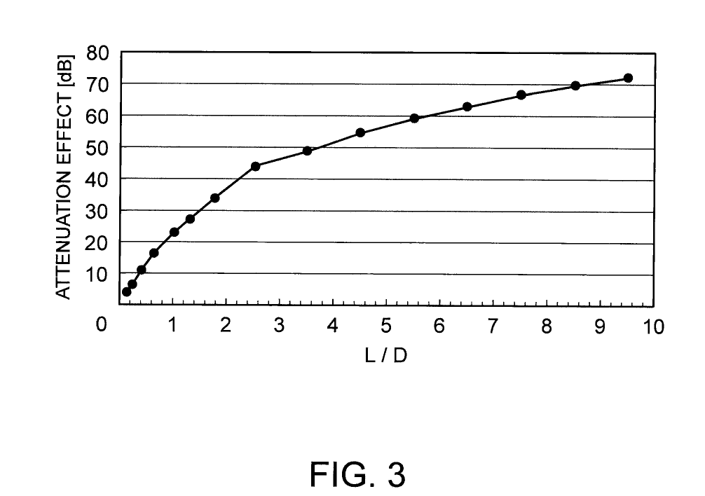

FIG. 3 is a graph showing the relationship between the ratio L/D between the length L from an end of the discharge lamp of this embodiment to the opening of the reflector and the inside surface length D of the opening of the reflector and the attenuation effect.

This graph shows the attenuation effect of the electromagnetic waves in a position 10 cm away from the opening of the reflector, the attenuation effect obtained when the frequency of the microwaves is set at 2.45 GHz and L/D is changed.

Incidentally, it has been confirmed that, when the light source device is housed in the case, an attenuation of 20 dB satisfies the standard specifying the amount of leaked electromagnetic waves for preventing extraneous emissions.

As shown in FIG. 3, as L/D is increased, the attenuation effect of the electromagnetic waves is increased. For example, when L/D=3.6, the attenuation effect of 50 dB is obtained.

An attenuation of 20 dB is sufficient for satisfying the standard specifying the amount of leaked electromagnetic waves. Thus, according to the graph, this standard is satisfied when L/D≧0.8.

In addition, it has been confirmed that a luminance efficiency of 70 Lm/W is obtained when a 200 W mercury lamp is used, D=50 mm, and L=70 mm in the light source device of this embodiment. In this way, it has been confirmed that an adequate light use efficiency is obtained.

As described above, in the light source device 1 of this embodiment, the relationship between the wavelength λ of the microwaves, the inside surface length D which is the inside diameter of the opening of the reflector 40 or a long side of a hollow space, and the length L from an end of the discharge lamp 35 to the opening of the reflector 40 is set so that D≦λ/2 and L/D≧0.8.

By doing so, it is possible to obtain an adequate light use efficiency while keeping the amount of electromagnetic waves which leak out from the light source device 1 less than or equal to a predetermined value.

Moreover, it is possible to reduce the leaked electromagnetic waves without attaching other parts to the reflector 40 and miniaturize the light source device 1.

### MODIFIED EXAMPLE 1

Next, as a modified example of the first embodiment, a modified example in which a reflector of a light source device is provided with an optical element will be described. Modified Example 1 has the same structure as the first embodiment except for the optical element. Therefore, such parts as are found also in the first embodiment are identified with the same reference numerals and their descriptions will be omitted.

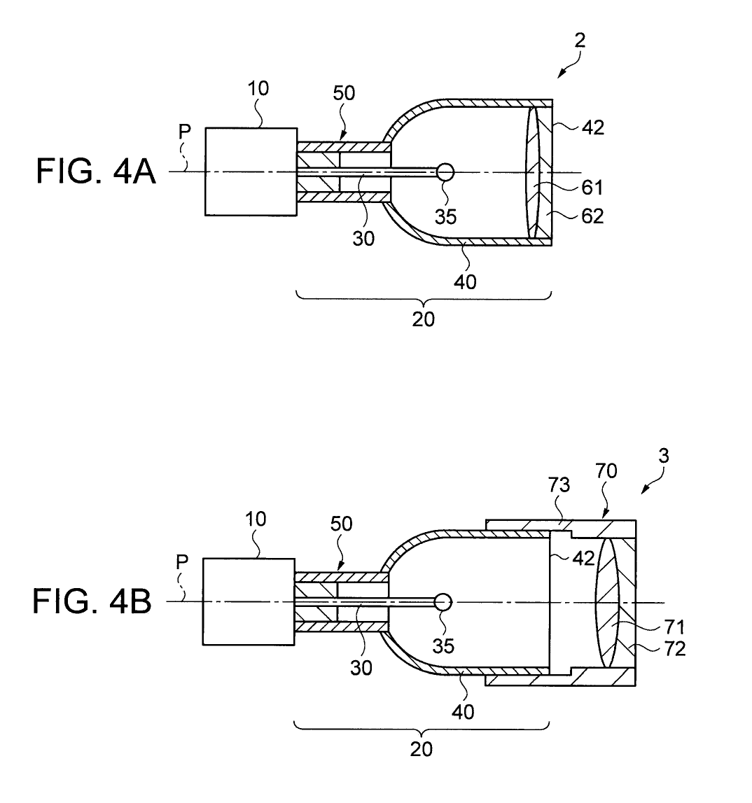

FIGS. 4A and 4B are schematic sectional views showing the structures of the light source device of the modified example.

As shown in FIG. 4A, a light source device 2 is provided with optical lenses 61 and 62 near an opening of the reflector 40. The optical lenses 61 and 62 are bonded to the inside of the reflector 40 with a heat-resistant adhesive or the like.

The optical lens 61 is a convex lens, and the optical lens 62 is a concave lens. By combining these lenses, luminous flux is condensed or converted into parallel light. The combination of these lenses is not limited to this modified example, and the lenses can be appropriately combined in other ways in accordance with the intended use.

As described above, by providing the reflector 40 with the optical lenses 61 and 62, the light guiding distance from the discharge lamp 35 serving as a light source to the optical lenses 61 and 62 can be shortened. This improves the light use efficiency. Moreover, it is possible to condense luminous flux or convert luminous flux into parallel light at the exit of the luminous flux. This increases optical design flexibility.

In addition, a light source device 3 fitted with an optical lens unit 70 at the tip of the reflector 40 as shown in FIG. 4B is shown as another modified example.

The optical lens unit 70 is formed as a tubular lens housing 73 to which optical lenses 71 and 72 are bonded. The optical lenses 71 and 72 are bonded to the lens housing 73 with a heat-resistant adhesive or the like. Moreover, a thread is formed at a part where the lens housing 73 and the reflector 40 engage, allowing the optical lens unit 70 to move along an optical axis P.

As described above, since the reflector 40 is fitted with the optical lens unit 70, it is possible to use one light source device for a plurality of applications by preparing a plurality of optical lens units used for different purposes.

### MODIFIED EXAMPLE 2

Next, as Modified Example 2 of the first embodiment, a modified example in which the central conductor 30 of a light source device is covered with silica glass will be described. In Modified Example 2, such parts as are found also in the first embodiment are identified with the same reference numerals and their descriptions will be omitted.

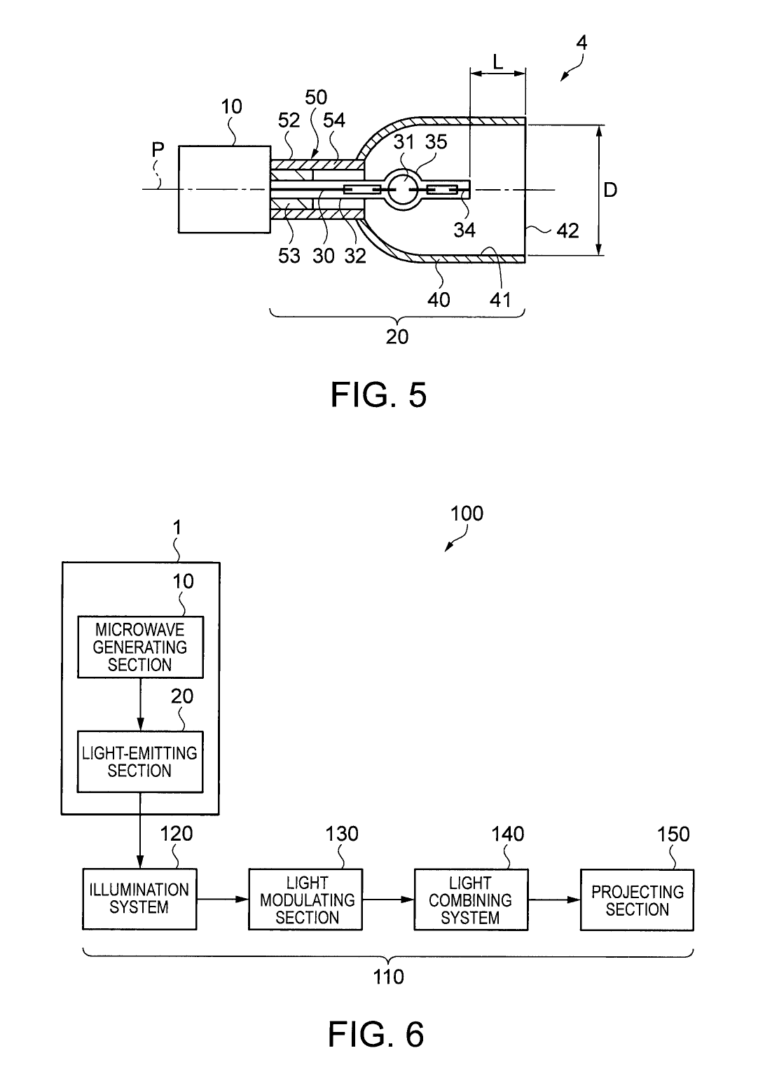

FIG. 5 is a schematic sectional view showing the structure of a light source device of the modified example.

As shown in FIG. 5, the central conductor 30 of a light source device 4 extends in the direction of an optical axis P from the inside of the microwave generating section 10, and a silica tube 32 formed of transparent silica glass is provided so as to cover the outer circumference of the central conductor 30.

Part of the silica tube 32, the part surrounded by the reflector 40, is swollen in a nearly globular shape. Inside the globular part, a space 31 is formed, and light-emitting material is encapsulated therein. In the space 31, the central conductor 30 extending from the inside of the microwave generating section 10 and a conductor 34 extending from the tip of the silica tube 32 are placed with a predetermined distance left therebetween. As described above, the light source device 4 has a structure in which the central conductor 30, the silica tube 32, and the discharge lamp 35 are integrated into one part.

The microwaves generated by the microwave generating section 10 are emitted into the space 31 after passing through the coaxial tube 50, and plasma is concentrated on the space 31 by the conductor 34 placed at the tip of the silica tube 32. As a result, the light-emitting material in the space 31 is exited (ionized) and plasma emission is produced, whereby the discharge lamp 35 emits light.

Moreover, the relationship between the wavelength λ of the microwaves, the inside surface length D which is the inside diameter of the opening 42 of the reflector 40, and the length L from an end of the discharge lamp 35 to the opening 42 of the reflector 40 is set so that D≦λ/2 and L/D≧0.8.

With such a structure of Modified Example 2, the same effects as those of the first embodiment can be obtained.

Incidentally, the reflector 40 of the light source device 4 of Modified Example 2 may be provided with the optical element described in Modified Example 1.

### Second Embodiment

Subsequently, a projector as a projection display device adopting the above-described light source device will be described with reference to the drawing.

FIG. 6 is a block diagram showing the schematic configuration of a projector of this embodiment.

A projector 100 includes the above-described light source device 1 and an optical system 110.

The optical system 110 has an illumination system 120, a light modulating section 130, a light combining system 140, and a projecting section 150. Moreover, the light source device 1 has a microwave generating section 10 and a light-emitting section 20.

Next, the operation of the projector 100 will be described. The microwave generating section 10 emits the microwaves, and the light-emitting section 20 emits light by the microwaves emitted from the microwave generating section 10. Moreover, the illumination system 120 makes the illumination intensity of the luminous flux emitted from the light source device 1 uniform, and separates the luminous flux into lights of different colors.

The light modulating section 130 forms optical images by modulating the luminous flux of lights of different colors according to the image information, the lights of different colors separated by the illumination system 120. The light combining system 140 combines the optical images of lights of different colors separated by the illumination system 120 and subjected to the modulation by the light modulating section 130, and the projecting section 150 projects an optical image.

The discharge lamp incorporated in the projector 100 is a lamp using microwaves. Thus, as compared with a projector provided with an illumination device using an existing discharge lamp, it is possible to prolong the life of the light source device 1, alleviate the inconvenience of replacing the light source device with another, and enhance the economical effect.

Moreover, by adopting the above-described light source device 1, it is possible to provide the projector 100 which improves the use efficiency of the light emitted from the discharge lamp while keeping the amount of electromagnetic waves which leak out from the light source device 1 less than or equal to a predetermined value.

The entire disclosure of Japanese Patent Application No. 2009-235997, filed Oct. 13, 2009 is expressly incorporated by reference herein.

What is claimed is:

1. A light source device comprising:
a microwave generating section generating microwaves;
a central conductor connected to the microwave generating section and emitting the microwaves;
a discharge lamp connected to the central conductor and emitting light by the microwaves; and
a reflector surrounding the discharge lamp, the reflector which has an opening at one end thereof and is formed of conductor material, wherein
the relationship between a wavelength λ of the microwaves, an inside surface length D which is an inside diameter of the opening of the reflector or a maximum length of a cross-sectional shape of the opening of the reflector, and a length L from a first end of the discharge lamp opposite to a second end connected to the central conductor to the opening of the reflector is D≦λ/2 and L/D≧0.8.

2. The light source device according to claim 1, wherein a surface of the reflector, the surface facing the discharge lamp, is formed of at least metal material.

3. The light source device according to claim 1, wherein the discharge lamp is placed in an optical focal position of the reflector.

4. The light source device according to claim 1, wherein a transmission mode of high-frequency waves transmitted from the microwave generating section is a TEM mode.

5. The light source device according to claim 1, wherein the reflector includes an optical element which efficiently focuses or polarizes light on an optical axis of luminous flux emitted from the discharge lamp.

6. A projection display device comprising:
a light source device;
a light modulating section forming an optical image by modulating luminous flux emitted from the light source device according to input image information; and
a projecting section projecting the optical image formed by the light modulating section,
the light source device including:
a microwave generating section generating microwaves;
a central conductor connected to the microwave generating section and emitting the microwaves;
a discharge lamp connected to the central conductor and emitting light by the microwaves; and
a reflector surrounding the discharge lamp, the reflector which has an opening at one end thereof and is formed of conductor material,
the light source device in which the relationship between a wavelength λ of the microwaves, an inside surface length D which is an inside diameter of the opening of the reflector or a maximum length of a cross-sectional shape of the opening of the reflector, and a length L from a first end of the discharge lamp opposite to a second end connected to the central conductor to the opening of the reflector is D≦λ/2 and L/D≧0.8.
